(19) United States
(12) Patent Application Publication
(10) Pub. No.: US 2026/0031001 A1
(43) Pub. Date: Jan. 29, 2026

(54) LAWN SIGN AND ATTACHMENT KIT FOR ATTACHING SIGN

(71) Applicant: Tracer Imaging LLC, Ossining, NY (US)

(72) Inventor: Ryan Kelly, Queens, NY (US)

(73) Assignee: Tracer Imaging LLC, Ossining, NY (US)

(21) Appl. No.: 19/280,917

(22) Filed: Jul. 25, 2025

Related U.S. Application Data
(60) Provisional application No. 63/676,506, filed on Jul. 29, 2024.

(51) Int. Cl. G09F 7/18

(52) U.S. Cl. CPC G09F 7/18; G09F 2007/1843; G09F 2007/1873

(57) ABSTRACT

A lawn sign attachment kit for attaching a sign to a sign frame and includes a pair of connectors. Each connector has a flexible first leg, a flexible second leg and a corner. The first leg has a first hole formed therein and the second leg has a second hole formed therein. The corner includes a coupling post that extends outwardly from the body and is configured: (1) such the flexible first leg can be folded over and the coupling post is received within the first hole to establish a snap-fit between the coupling post and the flexible first leg and define a first looped structure; and (2) such that the flexible second leg can be folded over and the coupling post is received within the second hole to establish a snap-fit between the coupling post and flexible second leg and define a second looped structure.

### CROSS REFERENCE TO RELATED APPLICATION

This application is based on and claims priority to U.S. Provisional Patent Application 63/676,506, filed Jul. 29, 2024, and is related to U.S. patent application Ser. No. 17/889,676, filed Aug. 17, 2022, each of which is hereby incorporated by reference, as if expressly set forth in its respective entirety herein.

### TECHNICAL FIELD

The present application relates to lawn signs and more particularly to an attachment kit for attaching a lawn sign to a lawn sign frame.

### BACKGROUND

Lawn signs are used in many different settings and for different purposes. In general, a lawn sign holds a sign and is configured to be implanted into the ground (the yard). Some uses of a lawn sign are to celebrate a birthday or graduation or display an allegiance to a sport's team. In addition, lawn signs are heavily used in political campaigns. In particular, lawn signs are often also placed near polling places on election day. Signs come in various shapes and sizes but are most often rectangular and between 12 and 40 inches on each side. They are usually produced in packages that include lawn sign wires since most of these lawn signs need to be placed on a grass or dirt surface.

### SUMMARY

A lawn sign attachment kit for attaching a sign to a sign frame. The kit includes a pair of connectors. Each connector has a flexible first leg, a flexible second leg and a corner at which the first leg and second leg intersect. The first leg has a first hole formed therein and the second leg has a second hole formed therein. The corner includes a coupling post that extends outwardly from the body and is configured: (1) such the flexible first leg can be folded over and the coupling post is received within the first hole to establish a snap-fit between the coupling post and the flexible first leg and define a first looped structure; and (2) such that the flexible second leg can be folded over and the coupling post is received within the second hole to establish a snap-fit between the coupling post and flexible second leg and define a second looped structure.

### BRIEF DESCRIPTION OF THE DRAWING FIGURES

FIG. 1 is a top plan view of a connector according that is configured to attach a sign to a lawn sign frame;

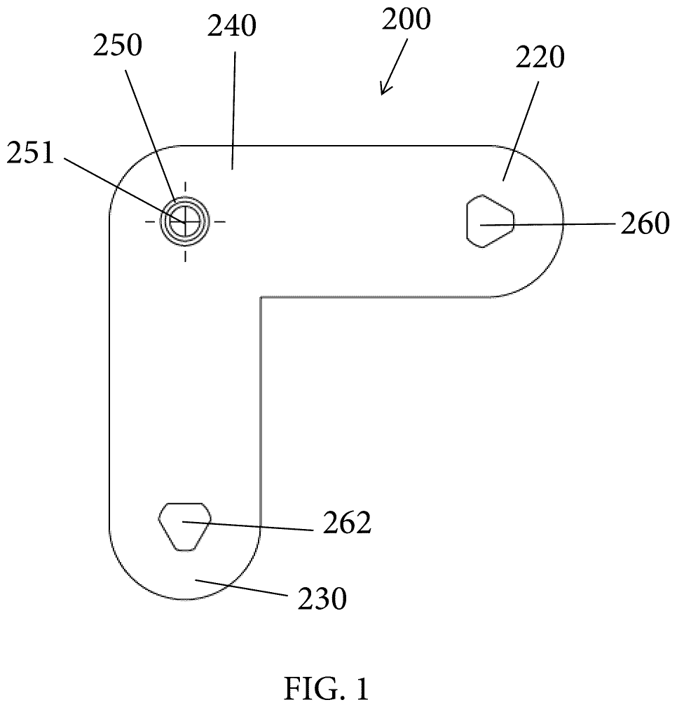

FIG. 2 is a perspective view thereof;

FIG. 3 is a side elevation view thereof;

FIG. 4 shows one step of positioning the connector of FIG. 1 relative to a side of the sign that is draped over a lawn sign frame:

FIG. 5 shows a step of folding one part of the connector for placement along the one side of the sign;

FIG. 6 shows another step of folding another part of the connector for placement along another side of the sign to complete attachment of the sign to the frame;

FIG. 7 is a template of the foldable sign for placement over the sign frame;

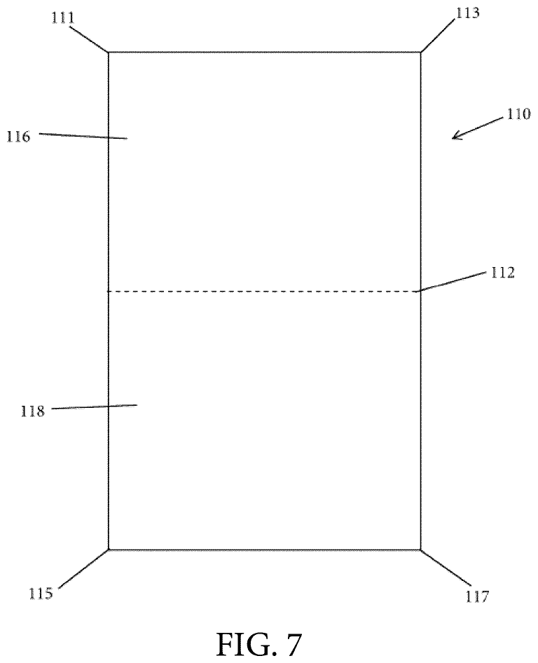

FIG. 8 is a view of the sign frame; and

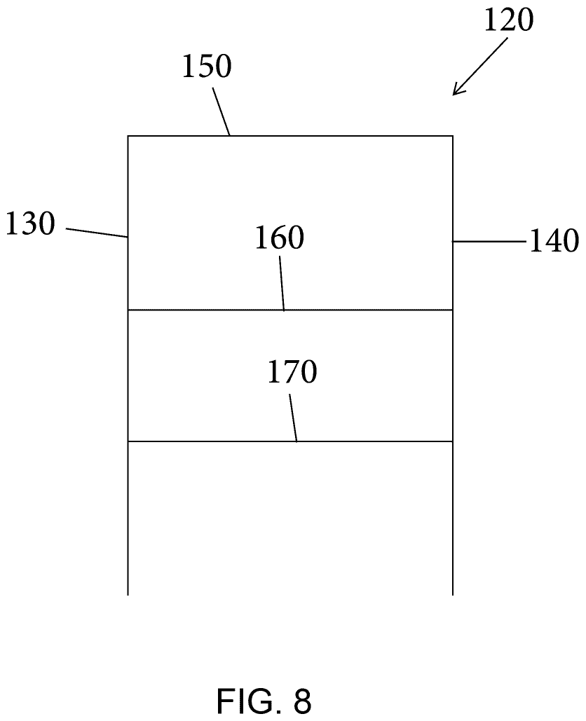

FIG. 9 is a view of an optional cap.

### DETAILED DESCRIPTION OF CERTAIN EMBODIMENTS

The figures illustrate one exemplary lawn (yard) sign 100, The lawn sign 100 generally is formed of a sign (substrate) 110; a sign frame 120 and a pair of connectors 200 for attaching the sign 110 to the sign frame 120.

The sign 110 can be formed from any number of different materials that are suitable for the intended application. In one embodiment, the sign 110 is formed of a foldable material and more particularly, is formed of a material that can be folded on top of itself. The sign 110 can have a rectangular shape with a first half 116 and a second half 118. The sign 110 is of a type that can be folded in half to define a folded top section 112 (in its folded state) and a pair of free edges that represent the two ends of the unfolded sign 110. The folded top section 112 represents the middle section of the sign in its unfolded, flat state, Typically, the sign 110 has a parallelogram shape. The sign 110 has a first corner 111, a second corner 113, a third corner 115, and a fourth corner 117.

In one embodiment, the sign 110 is formed of a fabric material (e.g., canvas) that withstand the elements (outdoor environment).

The sign frame 120 can have any number of different shapes and sizes. One common type of lawn sign frame is an “H-frame”. This type of frame is defined by a left frame member or left rail or left tine 130 and a right frame member or right rail or right tine 140. One or more crossbars are located between the left tine 130 and right tine 140 and more particularly, the illustrated sign frame 120 contains a first (top) crossbar 150, a second (middle) crossbar 160 and a third (bottom) crossbar 170. The crossbars 150, 160, 170 adds strength and makes the entire frame one single unit. The left tine 130 and the right tine 140 are parallel to one another and the three crossbars 150, 160, 170 are parallel to one another and are oriented perpendicular to the left tine 130 and the right tine 140.

It will be appreciated that the third crossbar 170 can be eliminated.

The sign frame 120 can be formed of many different materials, such as metals or plastics. The various parts of the frame are attached using traditional techniques, such as welding, etc.

As shown in the figures, each connector 200 is configured to attach the sign 110 to the sign frame 120. An attachment kit can be provided and incudes two connectors 200. The attachment kit is designed to attach the sign 110 in its folded state to the sign frame 120. In particular, the sign 110 is intended to be folded over the first crossbar 150 such that the folded top section 112 is draped over the first crossbar 150 and the two free edges (ends) of the sign 110 are positioned near the second crossbar 160. The distance between the first crossbar 150 and the second crossbar 160 is thus generally the size of one half of the sign 110 which can also be considered to be one side face of the sign 110. The sign 110 is typically configured such that in the folded state, the two side faces that face in opposite directions contain graphic matter.

The sign 110 with its two free edges which represent a top edge and a bottom edge in the unfolded state. The sign 110 has a first corner 111, a second corner 113, a third corner 115 and a fourth corner 117.

One connector 200 is used on one side of the sign frame 110 and another connector 200 is used on the other side of the sign frame 110. For example, the one connector 200 can be considered to be a left connector and the other connector 200 can be considered to be a right connector 200.

The one connector 200 is used to attach the first corner 111 to the third corner 115 and the other connector 200 is used to attach the second corner 113 to the fourth corner 117 as described below.

Each connector 200 is defined by a first leg (first end portion) 220, an opposing second leg (end portion) 230 and an intermediate portion 240. As shown in the figures, the connector 200 is generally L-shaped and therefore, the first and second legs 220, 230 are formed at a 90 degree with the intermediate portion 240 being where the two legs 220, 230 join one another. The connector 200 has a first face 202 and an opposite second face 204. The first face 202 has raised features as described herein, while the second face 204 is a flat surface. As described herein, the body of the connector 200 is flexible and therefore, each of the first leg 220 and the second leg 230 can fold over on top of itself. For example, the body of the connector 200 can be formed of a plastic material.

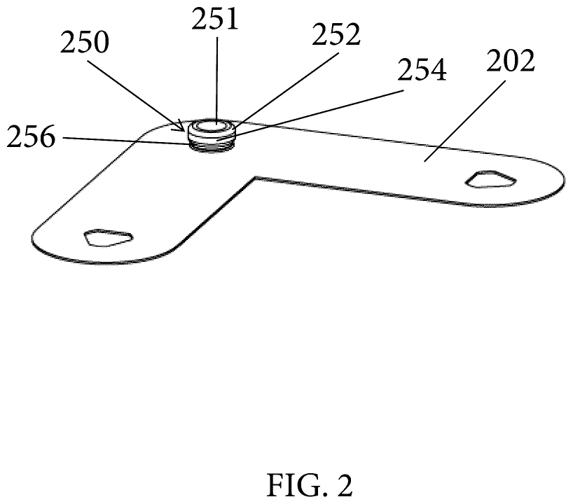

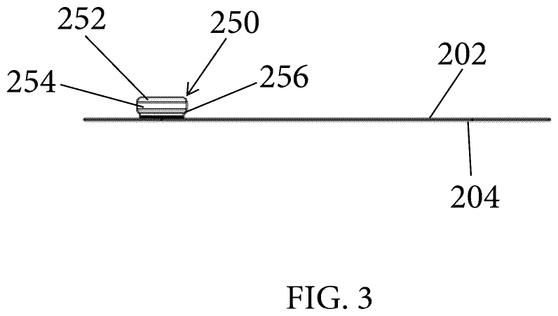

As described in more detail herein, the connector 200 has a coupling post 250 that protrudes outwardly from the first face 202 and is located within the intermediate portion 240. The coupling post 250 is formed perpendicular to the first face 202 and is located in the corner of the connector 200 and can be integrally formed with the body of the connector 200. The profile of the coupling post 250 is best shown in FIGS. 2 and 3. The coupling post 250 can be a hollow structure and thus, has a center hole 251. As described herein, the center hole 251 can be a threaded hole. The coupling post 250 has a curved or sloped top portion 252 and a wider center portion 254 and a bottom undercut portion 256. The top portion 252 thus slopes outward to the wider center portion 254 and the bottom undercut portion 256 is below the wider center portion 254. The bottom undercut portion 256 has a width (diameter) less than the wider center portion 254.

The first leg 220 has a first opening (first hole) 260 formed therein and similarly, the second leg 230 has a second opening (second hole) 262 formed therein. The first opening 260 is proximate to and close to the free end of the first leg 220 and similarly, the second opening 262 is proximate to and close to the free end of the second leg 230.

The first and second openings 260, 262 can have any number of different shapes so long as they function in the manner described herein and are complementary to the coupling feature described herein. In the illustrated embodiment, each of the first and second openings 260, 262 is three sided and thus, is generally triangular shape. However, it will be appreciated that other shapes are possible for the openings including circular shaped, shapes with two to four sides and irregular shapes.

Each of the first and second openings 260, 262 is specifically designed to provide a snap-fit with the coupling post 250 and therefore, the opening of each of the first and second openings 260, 262 that receives the coupling post 250 is undersized relative to the width (diameter) of the coupling post 250. The profile of the coupling post 250 is intentionally designed in view of the size and shape of each of the first and second openings 260, 262. More specifically, the outwardly sloped top portion 252 of the coupling post 250 when received within one of the first and second openings 260, 262 serves to expand the opening by locally deforming the edges of the connector 200 around the opening. As the coupling post 250 is further advanced into the opening and the wider center portion 254 encounters the edges of the connector, further expansion and deformation of the edges results in order to allow the wider center portion 254 to pass through the opening. Further advancement of the coupling post 250 within the opening results in the bottom undercut portion 256 encountering the edges and since the bottom undercut portion 256 has a width less than the wider center portion 254, the deformation of the edges reverses and the body of the connector, including these edges flex back and enter into the bottom undercut portion 256. This action results in a snap-fit (interference fit) between the body of the connector 200 and the coupling post 250, when the connector 200 is folded in the manner described herein.

### Method of Assembly

The method of assembly the lawn sign consists of the following steps.

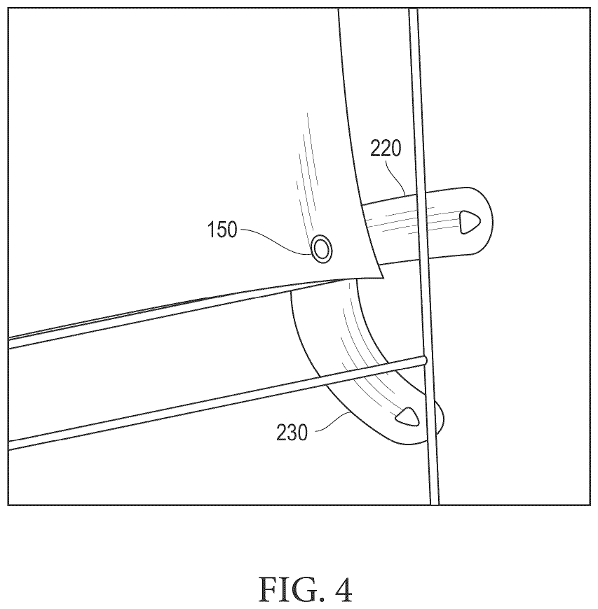

First, the sign 110 is folded over the first crossbar 150 such that the folded top section 112 is draped over the first crossbar 150 and the two free edges 114 of the sign 110 are positioned near the second crossbar 160. In this position, the first corner 111 and the third corner 115 overlap and the second corner 113 and the fourth corner 117 overlap. As shown in the figures, each of the first corner 111, second corner 113, third corner 115 and fourth corner 117 includes an opening. When the sign 110 is folded in half, the openings in the first and third corners overlap and the openings in the second and fourth corners overlap. FIG. 4 shows this step.

FIG. 4 shows the next step of positioning one connector 200 relative to one corner of the folded sign. For example. FIG. 4 show the connector 200 relative to bottom right corner where the second corner 113 and the fourth corner 117 overlap. The connector 200 is positioned such that the first leg 220 faces to the right and extends across and outside of the second tine 140 and the second leg 230 faces downward across and below the second crossbar 160. The connector 200 is positioned along one face of the folded sign. For example, in FIG. 4, the connector 200 is positioned along the rear face of the folded sign. The coupling post 150 is inserted through the openings formed in the second corner 113 and the fourth corner 117. The openings in the two corners are circular and complement the circular shape of the coupling post 150. The height of the coupling post 150 is such that the coupling post completely passes through the folded sign.

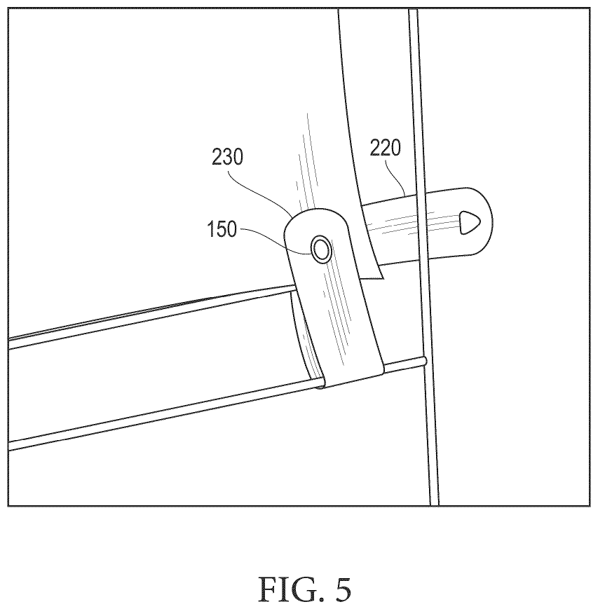

Next one of the first and second legs 220, 230 is folded over and engages the coupling post 150. In FIG. 5, the second leg 230 is first folded; however, it will be appreciated that instead, the first leg 220 can be first folded. In FIG. 5, the second leg 230 is folded upright and is folded about the second crossbar 160, thereby capturing the second crossbar 160. The second leg 230 is folded such that the coupling post 150 is inserted into the second opening 262. As described herein, a snap-fit results between the second leg 230 and the coupling post 150. In the snap-fit position, the edges of the second leg 230 are secured within the bottom undercut portion 256. The result is that the bottom right corner of the sign 110 is secured to the second crossbar 160.

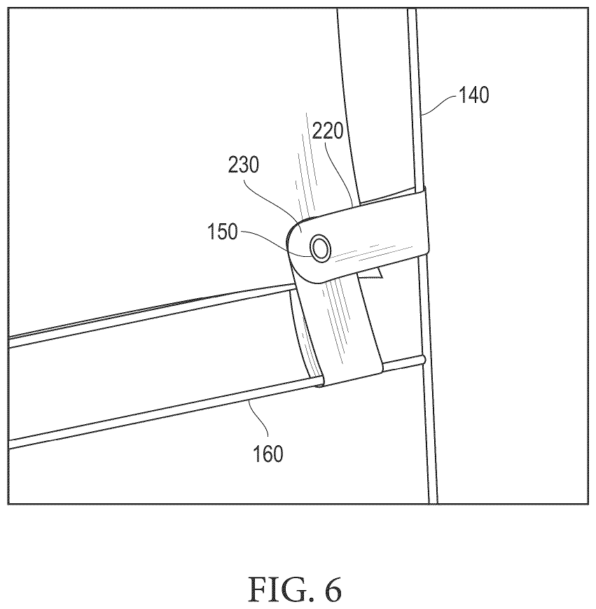

Next, the other of the first and second legs 220, 230 is folded over and engages the coupling post 150. In FIG. 6, the first leg 220 is next folded. The first leg 220 is folded to the left and is folded over and about the second tine 140, thereby capturing the second tine 140. The first leg 220 is folded such that the coupling post 150 is inserted into the first opening 260, with the first leg 220 being positioned over the folded second leg 230. As described herein, a snap-fit results between the first leg 220 and the coupling post 150. In the snap-fit position, the edges of the first leg 220 are secured within the bottom undercut portion 256. The result is that the bottom right corner of the sign 110 is secured to the second tine 140, with the first leg 220 disposed over the second leg 230,

FIG. 6 shows the connector in its fully attached state.

When assembled, the sign 110 is under tension and is securely attached to and supported by the sign frame 120.

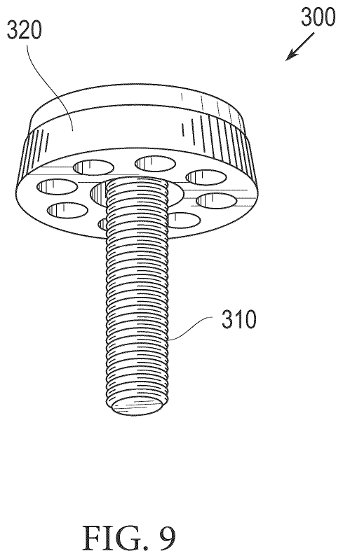

Now turning to FIG. 9, it will be appreciated that an optional cap 300 can be provided for finishing off the coupling post 150 and also for adding additional securement of the sign. For example, the cap 300 can have a threaded shaft 310 that is configured to threadingly engage inner threads formed in the center hole 151 of the coupling post 150. The cap 300 is thus screwed into the hole 151. The cap 300 can have an enlarge head 320 that sits on and closes off the free end of the coupling post 150, thereby providing a finished look. In addition, the head 320 serves to prevent the dislodgement of the folded sign from the coupling post 150.

It is to be understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

What is claimed is:

1. A lawn sign connector for attaching a sign to sign frame comprising:
a body having a flexible first leg, a flexible second leg and a corner at which the first leg and second leg intersect, the first leg having a first hole formed therein and the second leg having a second hole formed therein, the corner including a coupling post that extends outwardly from the body and is configured: (1) such the flexible first leg can be folded over and the coupling post is received within the first hole to establish a snap-fit between the coupling post and the flexible first leg and define a first looped structure; and (2) such that the flexible second leg can be folded over and the coupling post is received within the second hole to establish a snap-fit between the coupling post and flexible second leg and define a second looped structure.

2. The lawn sign connector of claim 1, wherein the body is formed of a flexible plastic material.

3. The lawn sign connector of claim 1, wherein the body has an L-shape and the first leg and the second leg are formed at a 90 degree angle.

4. The lawn sign connector of claim 1, wherein the first hole is proximate to a free end of the first leg and the second hole is proximate to a free end of the second leg.

5. The lawn sign connector of claim 1, wherein each of the first hole and second hole is defined by three edges.

6. The lawn sign connector of claim 1, wherein a width of each of the first hole and the second hole is less than a maximum width of the coupling post.

7. The lawn sign connector of claim 1, wherein the coupling post is integrally formed with the body.

8. The lawn sign connector of claim 1, wherein the coupling post includes a sloped top portion, a center portion, and a bottom undercut portion, wherein the coupling post has a maximum width within the center portion.

9. The lawn sign connector of claim 8, wherein the sloped top portion has an outward slope towards the center portion.

10. The lawn sign connector of claim 8, wherein edges that define each of the first hole and the second hole are received within the bottom undercut portion to establish the snap-fit between the first leg and the coupling post and the snap-fit between the second leg and the coupling post.

11. The lawn sign connector of claim 1, wherein the first hole and the second hole have a same shape.

12. The lawn sign connector of claim 8, wherein a width of the coupling post within the bottom undercut portion is equal or less than a maximum width of each of the first hole and the second hole.

13. The lawn sign connector of claim 8, wherein the coupling post has a cylindrical shape.

14. The lawn sign connector of claim 8, wherein one of the first looped structure and the second looped structure is disposed over the other of the first looped structure and the second looped structure.

15. The lawn sign connector of claim 1, wherein the coupling post is hollow.

16. The lawn sign connector of claim 15, wherein the coupling post has internal threads and further including a finishing cap that threadingly engages the coupling post.

17. The lawn sign connector of claim 16, wherein the finishing cap has a threaded stem and an enlarged head, the threaded stem threadingly engaging the internal threads with the enlarged head sitting against a top edge of the coupling post.

18. A lawn sign comprising:
a lawn sign having a first corner, a second corner, a third corner, and a fourth corner, wherein when the lawn sign is folded in half, the first corner and the third corner are superimposed and the second corner and the fourth corner are superimposed;
a lawn sign frame; and
a pair of connectors according to claim 1, one connector attaching the first corner to the third corner and being attached to the lawn sign frame, the other connector attaching the second corner to the fourth corner and being attached to the lawn sign frame.

19. A method for attaching a sign to a lawn sign frame that includes a left tine and parallel right tine and first and second crossbars connecting the left tine to the right tine, the method comprising the steps of:
providing a pair of connector, each connector including a flexible first leg, a flexible second leg and a corner at which the first leg and second leg intersect, the first leg having a first hole formed therein and the second leg having a second hole formed therein, the corner including a coupling post that extends outwardly from the body folding the sign in half over the first crossbar such that a first corner is superimposed over a third corner resulting in a first corner hole being aligned with a third corner hole and a second corner is superimposed over a fourth corner resulting in a second corner hole being aligned with a fourth corner hole;
positioning one connector such that the coupling post passes through the first corner hole and the third corner hole;
folding the first leg over the left tine such that the coupling post is inserted into the first hole and a snap-fit is formed between the first leg and the coupling post and a first looped structure is formed with the left tine being captured therein;
folding the second leg over the second crossbar such that the coupling post is inserted into the second hole and a snap-fit is formed between the second leg and the coupling post and a second looped structure is formed with the second crossbar being captured therein;
positioning another connector such that the coupling post passes through the second corner hole and the fourth corner hole;
folding the first leg over the right tine such that the coupling post is inserted into the first hole and a snap-fit is formed between the first leg of the other connector and the coupling post and a first looped structure is formed with the right tine being captured therein; and
folding the second leg over the second crossbar such that the coupling post is inserted into the second hole and a snap-fit is formed between the second leg of the other connector and the coupling post and a second looped structure is formed with the second crossbar being captured therein.
